(19) United States
(12) Patent Application Publication
(10) Pub. No.: US 2022/0381063 A1
(43) Pub. Date: Dec. 1, 2022

(54) ELECTRIC LOCK

(71) Applicant: YI-FAN LIAO, Taoyuan City (TW)

(72) Inventor: YI-FAN LIAO, Taoyuan City (TW)

(21) Appl. No.: 17/804,325

(22) Filed: May 27, 2022

(30) Foreign Application Priority Data
Jun. 1, 2021 (TW) 110206328

(51) Int. Cl. E05B 47/00

(52) U.S. Cl. CPC E05B 47/0001; E05B 2047/0016; E05B 2047/0035; E05B 63/08

(57) ABSTRACT

An electric lock, comprising: a case combining with a side plate and a case cover; a latch bolt, a latch bolt shaft and a latch bolt spring, the front end of the latch bolt shaft is combined with a blocking member, and the blocking member uses the elastic force of the latch bolt spring to stick out of the side plate to lock, when the external force applied to the latch bolt shaft is sufficient to resist the elastic force of the latch bolt spring, the blocking member will retract into the side plate to unlock; a unlock crank, having an electric push member, and a push member relative to the latch bolt shaft; and a linear actuator and an actuating arm, the front end of the actuating arm is combined with a push block relative to the electric push member, and a push block return spring is set relative to the push block.

### BACKGROUND OF THE INVENTION

### 1. Field of the Invention

The invention relates to an electric lock, especially the one that uses a same unlock crank to push the latch bolt shaft to unlock.

### 2. Description of the Related Art

US Patent No. US2016/0273243A1 disclosed an electric lock, it uses a motor to drive the clevis moving through a threaded lead screw for driving a second retraction lever to rotate, and by the rotation of the second retraction lever, it can against the biasing force that latch bolt spring applied to the latch bolt, so as to retract the latch bolt to unlock; moreover, when the user wants to restore the latch bolt to the locked state, stop the power supply to the motor, use the spring installed on the screw to reset the clevis, and use the latch bolt spring to reset the latch bolt; Furthermore, a key can also be used to rotate a key cylinder to drive a bolt lever to rotate, and then through the rotation of the bolt lever, the biasing force exerted by the latch bolt spring on the latch bolt can be resisted, make the latch bolt be retracted to unlock, and when the key is reset, the latch bolt is simultaneously reset by the latch bolt spring.

However, the prior art above mentioned can use a motor to unlock the lock electrically or manually with a key, and the motor uses the second retraction lever to retract the latch bolt to unlock, and the key uses the bolt lever to retract the lock bolt to unlock, so that the prior art above mentioned must be simultaneously installed with the second retraction lever and the bolt lever, the assembly procedure and the number of components are relatively complicated. In addition, the spring installed on the screw to reset the clevis should be a compression spring to resist the self-locking force of the motor. Since the restoring force of the compression spring must be adjusted through the combination of the diameter and length of the spring, the restoring force of the compression spring is difficult to adjust to an appropriate value. When the restoring force of the compression spring for resetting the clevis is too large, the resistance of the motor during electric unlocking will be too large, and the time required to complete the electric unlocking will be prolonged (even the lock cannot be unlocked). On the contrary, if the restoring force of the compression spring for resetting the clevis is too small, the restoring force of the latch bolt spring must be used to resist the self-locking force of the motor, so that the bolt may not be able to return to the locked state normally; Therefore, if the spring is only a linear compression spring, because the longer the distance of the compression spring is when the elastic force is released, the elastic force will decrease significantly, so there is a problem that the spring restoring force against the self-locking force of the motor will be difficult to adjust.

### SUMMARY OF THE INVENTION

It is a primary objective of the present invention to solve the problems of the prior art that the assembly process and the number of components are relatively complex, and has the effect of simplifying the assembly process and the number of components.

It is another objective of the present invention to has the effect of using a torsion spring to make it easier to adjust the spring restoring force that resists the self-locking force of the motor.

In order to achieve the above objectives, the present invention comprise: a case combining with a side plate and a case cover; a latch bolt, a latch bolt shaft and a latch bolt spring are arranged inside the case, the front end of the latch bolt shaft is combined with a blocking member, and the blocking member uses the elastic force of the latch bolt spring to stick out of the side plate to lock, when the external force applied to the latch bolt shaft is sufficient to resist the elastic force of the latch bolt spring, the blocking member will retract into the side plate to unlock; a unlock crank pivoted inside the case, having an electric push member, and a push member relative to the latch bolt shaft; and a linear actuator is arranged inside the case and has an actuating arm, the front end of the actuating arm is combined with a push block relative to the electric push member, and a push block return spring is set relative to the push block.

Also, the unlock crank further include a manual push member, a lock cylinder arranged inside the case, and an actuating cam wheel relative to the manual push member.

Also, the push block return spring is a torsion spring, the torsion spring is set on the case or the case cover by using a first shoulder bolt, the first rotating arm of the torsion spring is positioned on the case or the case cover, the outer end of a second rotating arm of the torsion spring is against the front edge of the push block; wherein the first rotating arm of the torsion spring is positioned on the case or the case cover by a second shoulder bolt or a positioning hole. The linear actuator is a linear stepping motor. The latch bolt shaft and the latch bolt spring are set inside the case by using a latch bolt bracket.

Whereby, whether the push block is pushed forward by the actuating arm of the linear actuator, the unlock crank is pushed and rotated through the electric push member, and the latch bolt shaft is pushed by the push member, so that the blocking member is retracted into the side plate and the lock is electrically unlocked; Or use the key to insert the lock cylinder to rotate the actuating cam wheel, push the unlock crank through the manual push member, and the latch bolt shaft is pushed by the push member, so that the blocking member is retracted into the side plate and the lock is manually unlocked, both of two are all using the same the unlock crank pushes the latch bolt shaft to unlock.

### BRIEF DESCRIPTION OF THE DRAWINGS

FIG. 1 is a perspective views of the structure of the present invention;

FIG. 2 is a perspective views of the main structure of the present invention;

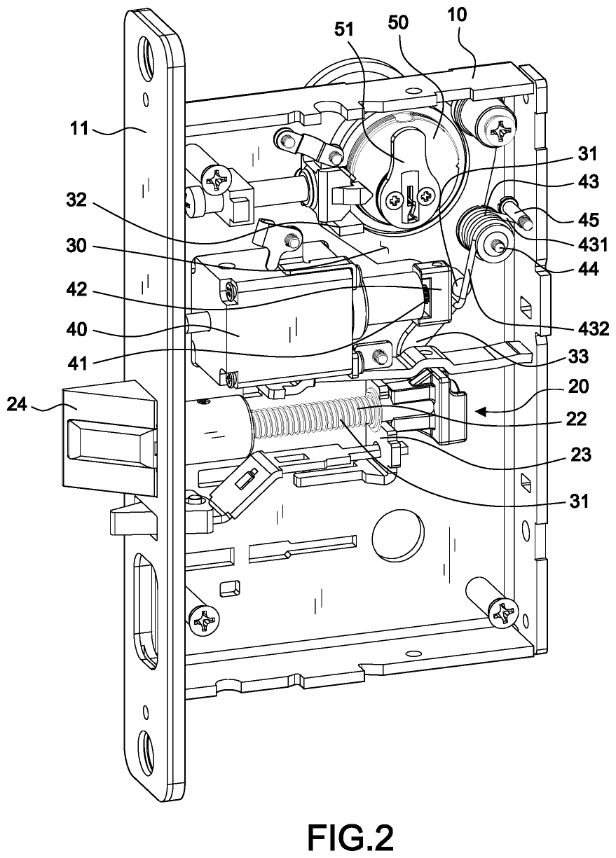

FIG. 3 is a perspective views of the unlock crank of the present invention;

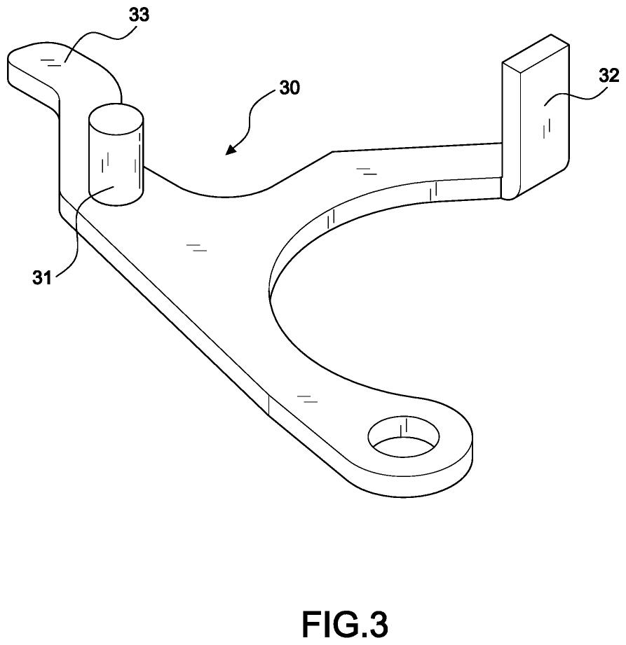

FIG. 4 is a schematic diagram illustrating locked state of the present invention;

FIG. 5 is a schematic diagram illustrating electric unlocked state of the present invention;

FIG. 6 is a schematic diagram illustrating manual unlocked state of the present invention.

### DETAILED DESCRIPTION OF THE PREFERRED EMBODIMENT

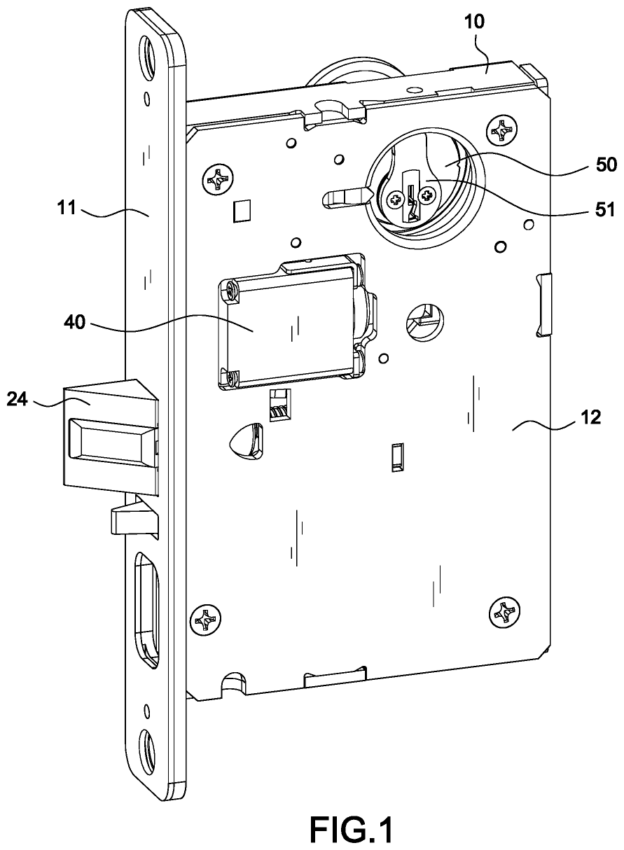

Referring to FIGS. 1˜3, the present invention includes: a case 10 combining with a side plate 11 and a case cover 12; a latch bolt 20, a latch bolt shaft 21 and a latch bolt spring 22 are arranged inside the case 10 by using a latch bolt bracket 23, the front end of the latch bolt shaft 21 is combined with a blocking member 24, and the blocking member 24 uses the elastic force of the latch bolt spring 22 to stick out of the side plate 11 to lock, when the external force applied to the latch bolt shaft 21 is sufficient to resist the elastic force of the latch bolt spring 22, the blocking member 24 will retract into the side plate 11 to unlock; a unlock crank 30 pivoted inside the case 10, having an electric push member 31, and a push member 33 relative to the latch bolt shaft 21; in this embodiment, the unlock crank 30 further include a manual push member 32. A linear actuator 40 is arranged inside the case 10 and has an actuating arm 41, the front end of the actuating arm 41 is combined with a push block 42 relative to the electric push member 31, and torsion spring 43 is set as a push block return spring relative to the push block 42, the torsion spring 43 is set on the case 10 or the case cover 12 by using a first shoulder bolt 44, the first rotating arm 431 of the torsion spring 43 is positioned on the case 10 or the case cover 12 by a second shoulder bolt 45 or a positioning hole, the outer end of a second rotating arm 432 of the torsion spring 43 is against the front edge of the push block 42; in this embodiment, further includes a lock cylinder 50 arranged inside the case 10, and an actuating cam wheel 51 relative to the manual push member 32.

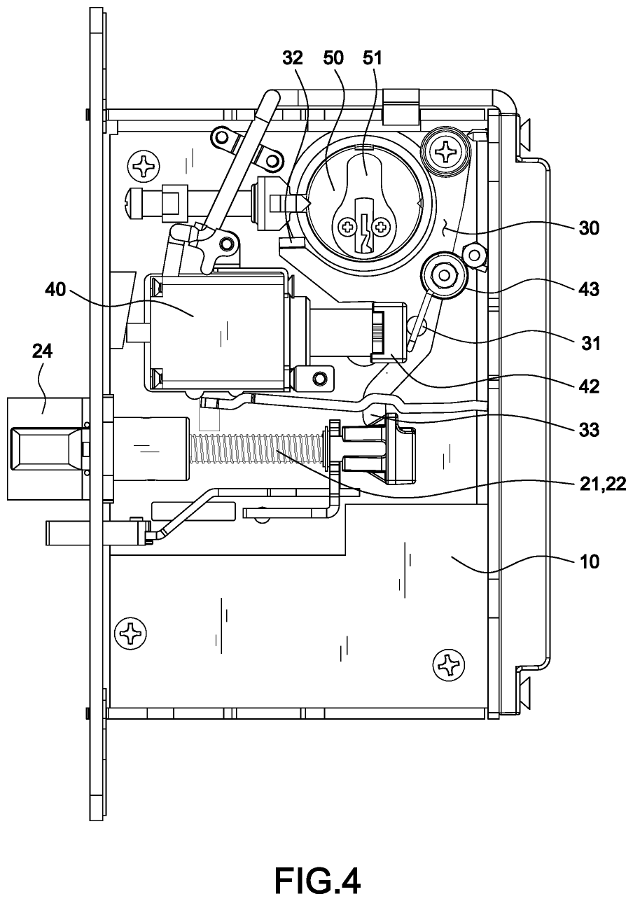

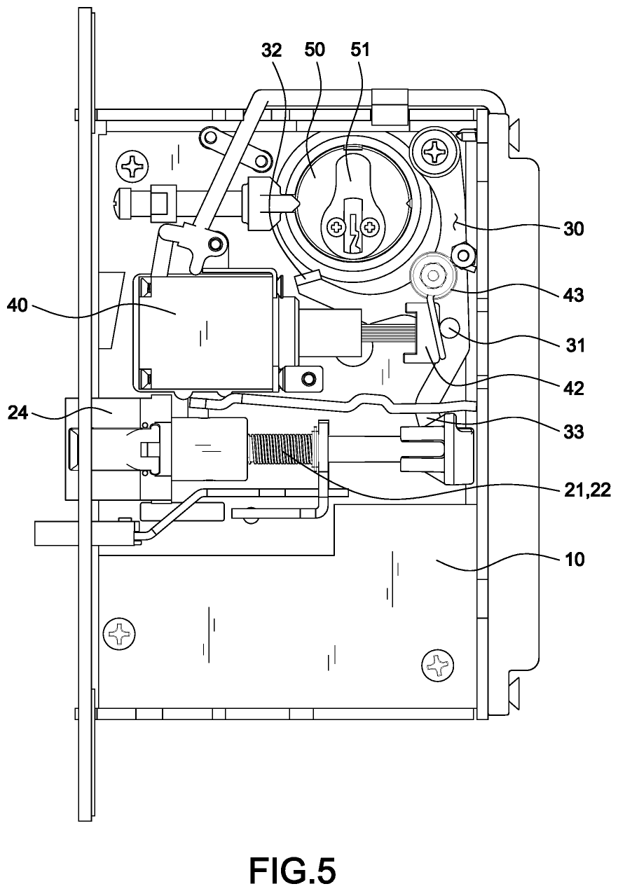

With the feature disclosed above, as FIG. 4 showing, the blocking member 24 uses the elastic force of the latch bolt spring 22 to stick out of the side plate 11 to lock. While unlocking, as FIG. 5 showing, using the actuating arm 41 of the linear actuator 40 to push the push block 42, rotating the unlock crank 30 through the electric push member 31, and using the push member 33 to push the latch bolt shaft 21, so as to make the blocking member 24 retract into the side plate 11 to unlock;

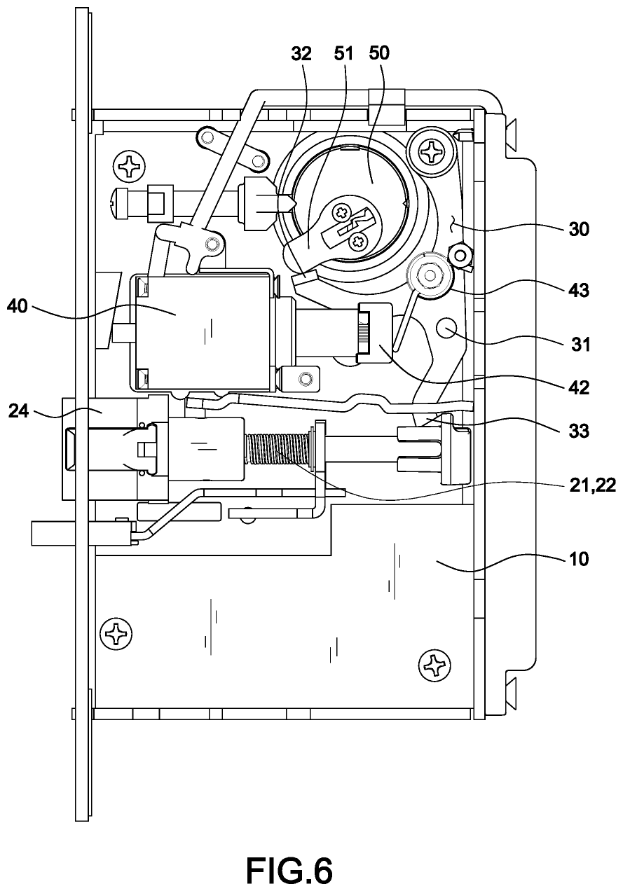

When the linear actuator 40 is powered off, the push block 42 is reset by the torsion spring 43, the blocking member 24 and the unlock crank 30 are reset by the latch bolt spring 22, so as to restore to the locked state, as showing in FIG. 4. Alternatively, as showing in FIG. 6, use the key to insert the lock cylinder 50 to rotate the actuating cam wheel 51, push the unlock crank 30 through the manual push member 32, and the latch bolt shaft 21 is pushed by the push member 33, so that the blocking member 24 is retracted into the side plate 11 and the lock is manually unlocked; The actuating cam wheel 51 is reset with the rotation of the key, the blocking member 24 and the unlock crank 30 are reset by the latch bolt spring 22, so as to restore to the locked state, as showing in FIG. 4. Therefore, the present invention is using the same unlock crank 30 to push the latch bolt shaft 21 to unlock during the electric unlocking or manual unlocking, which has the effect of simplifying the assembly procedure and the number of components.

In addition, when the linear actuator 40 is powered off and returning to the locked state from the electric unlocking state, the torsion spring 43 set relatively to the push block 42 can provide a restoring elastic force against the self-locking force of the linear actuator 40 for rest the push block 42, the blocking member 24 uses the elastic force of the latch bolt spring 22 to stick out of the side plate 11 to lock; since the spring restoring force of the torsion spring 43 is easier to adjust to an appropriate value (compared to the linear compression spring), the present invention also has the effect of using the torsion spring to make the spring restoring force resisting the self-locking force of the motor easier to adjust.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An electric lock, comprising:
a case combining with a side plate and a case cover;
a latch bolt, a latch bolt shaft and a latch bolt spring are arranged inside the case, the front end of the latch bolt shaft is combined with a blocking member, and the blocking member uses the elastic force of the latch bolt spring to stick out of the side plate to lock, when the external force applied to the latch bolt shaft is sufficient to resist the elastic force of the latch bolt spring, the blocking member will retract into the side plate to unlock;
a unlock crank pivoted inside the case, having an electric push member, and a push member relative to the latch bolt shaft; and
a linear actuator is arranged inside the case and has an actuating arm, the front end of the actuating arm is combined with a push block relative to the electric push member, and a push block return spring is set relative to the push block.

2. The electric lock as claimed in claim 1, wherein the push block return spring is a torsion spring, the torsion spring is set on the case or the case cover by using a first shoulder bolt, the first rotating arm of the torsion spring is positioned on the case or the case cover, the outer end of a second rotating arm of the torsion spring is against the front edge of the push block.

3. The electric lock as claimed in claim 2, wherein the first rotating arm of the torsion spring is positioned on the case or the case cover by a second shoulder bolt or a positioning hole.

4. The electric lock as claimed in claim 1, wherein the linear actuator is a linear stepping motor.

5. The electric lock as claimed in claim 3, wherein the latch bolt shaft and the latch bolt spring are set inside the case by using a latch bolt bracket.

6. The electric lock as claimed in claim 1, wherein the unlock crank further include a manual push member, a lock cylinder arranged inside the case, and an actuating cam wheel relative to the manual push member.

7. The electric lock as claimed in claim 6, wherein the push block return spring is a torsion spring, the torsion spring is set on the case or the case cover by using a first shoulder bolt, the first rotating arm of the torsion spring is positioned on the case or the case cover, the outer end of a second rotating arm of the torsion spring is against the front edge of the push block.

8. The electric lock as claimed in claim 7, wherein the first rotating arm of the torsion spring is positioned on the case or the case cover by a second shoulder bolt or a positioning hole.

9. The electric lock as claimed in claim 6, wherein the linear actuator is a linear stepping motor.

10. The electric lock as claimed in claim 8, wherein the latch bolt shaft and the latch bolt spring are set inside the case by using a latch bolt bracket.
